(19) United States
(12) Patent Application Publication
(10) Pub. No.: US 2022/0333224 A1
(43) Pub. Date: Oct. 20, 2022

(54) NICKEL-BASED SUPERALLOY WHICH IS EVEN SUITABLE FOR ADDITIVE MANUFACTURE, METHOD, AND PRODUCT

(71) Applicant: Siemens Energy Global GmbH & Co. KG, Munich, Bayern (DE)

(72) Inventors: Christoph Heinze, Markkleeberg (DE); Yves Küsters, Berlin (DE)

(73) Assignee: Siemens Energy Global GmbH & Co. KG, Munich, Bayern (DE)

(21) Appl. No.: 17/636,866

(22) PCT Filed: Aug. 12, 2020
(86) PCT No.: PCT/EP2020/072584

§ 371 Date: Feb. 19, 2022

(30) Foreign Application Priority Data
Sep. 2, 2019 (DE) 10 2019 213 214.6

(51) Int. Cl. C22C 19/05; B22F 10/28; B22F 12/41; B33Y 70/00; C22C 19/07; C22C 21/00; C22C 16/00; C22C 27/00

(52) U.S. Cl. CPC C22C 19/057; B22F 10/28; B22F 12/41; B33Y 70/00; C22C 19/056; C22C 19/07; C22C 21/00; C22C 16/00; C22C 27/00; B33Y 10/00

(57) ABSTRACT

Nickel-based superalloy suitable for additive manufacture, a method, and a product includes a special selection of the elements silicon, boron, zirconium, and hafnium. The nickel-based superalloy includes at least the following (in wt.%): carbon (C) 0.04%-0.08% chromium (Cr) 9.8%-10.2% cobalt (Co) 10.3%-10.7% molybdenum (Mo) 0.4%-0.6% tungsten (W) 9.3%-9.7% aluminum (Al) 5.2%-5.7% tantalum (Ta) 1.9%-2.1% boron (B) 0.0025%-0.01% zirconium (Zr) 0.0025%-0.01% hafnium (Hf) 0.1%-0.3%, and optionally yttrium (Y) and residual nickel (Ni).

### CROSS REFERENCE TO RELATED APPLICATIONS

This application is the US National Stage of International Application No. PCT/EP2020/072584 filed 12 Aug. 2020, and claims the benefit thereof. The International Application claims the benefit of German Application No. DE 10 2019 213 214.6 filed 2 Sep. 2019. All of the applications are incorporated by reference herein in their entirety.

### FIELD OF INVENTION

The invention relates to an alloy which offers particular advantages in the additive manufacture of metallic components, a process and a product.

The products are advantageously provided for use in a turbo machine, advantageously in the hot gas path of a gas turbine.

### BACKGROUND OF INVENTION

Additive manufacturing processes encompass, for example as powder bed process (PBF), selective laser melting (SLM) or laser sintering (SLS) or electron beam melting (EBM).

Further additive processes are, for example, “directed energy deposition (DED)” processes, in particular laser buildup welding, electron beam or plasma powder welding, wire welding, metallic powder injection molding, “sheet lamination” or thermal spraying processes (VPS/LPPS, GDCS).

A process for selective laser melting is known, for example, from EP 2 601 006 B 1.

Additive manufacturing processes have also been found to be particularly advantageous for complex or finely configured components, for example labyrinth-like structures, cooling structures and/or lightweight structures. In particular, additive manufacturing is advantageous due to a particularly short chain of process steps since a production or manufacturing step for a component can be carried out largely on the basis of a corresponding CAD file and selection of appropriate manufacturing parameters, thus providing an advantageous alternative, for example compared to the conventional production of high-performance components by casting, with the known disadvantageous process steps.

Additive manufacture using a nickel-based alloy, in particular by laser beam powder bed fusion (LB-PBF) or selective laser melting or electron beam powder bed fusion (EB-PBF), has hitherto often not given a crack-free overall structure, so that optimization in this respect is the subject of present-day development.

Nickel-based alloys according to the prior art are known, for example, from DE 10 2017 113780 Al, EP 3 034 639 Al and DE 10 2016 221470 Al.

### SUMMARY OF INVENTION

These problems have been addressed by the present invention and an alloy having relatively narrow specifications of critical elements has been defined, which alloy results in a crack-free additive structure or an additive structure which is sufficiently low in cracks to be tolerable for the intended use.

In the case of additive manufacturing technologies, especially in the case of powder bed-based processes (PBF), in particular, very high temperature gradients of sometimes more than 10⁶ K/s occur locally as a result of the process and these cause the above-described heating or solidification cracks.

It is an object of the invention to solve the abovementioned problem.

The object is achieved by an alloy, a process and a product.

### DETAILED DESCRIPTION OF INVENTION

The alloying elements have been matched in a targeted manner in order to be able to manufacture crack-free specimens.

Here, the elements silicon (Si), boron (B), zirconium (Zr) and hafnium (Hf) are of particular importance and carbon (C) likewise has to be taken into account, but modifications by hafnium (Hf) were most relevant.

The tendency to form solidification cracks in the production of a product composed of or comprising the alloy described can advantageously be decreased or entirely avoided by the present invention. This is based on a reduction in the proportion of liquid phase/eutectic in the temperature range from 1273K to the solidus temperature with simultaneous setting of a relatively small solidification interval.

The processability can also be improved, or the tendency to form cracks can be advantageously reduced, by the reduction in the γ′-solvus temperature via the present adaptation or selection of the Hf content.

Manufacture is advantageously carried out by means of LB-PB F.

The alloy advantageously has the following composition (in percent by weight):

| | |
|---|---|
| Carbon (C) | 0.04%-0.08% |
| Chromium (Cr) | 9.8%-10.2% |
| Cobalt (Co) | 10.3%-10.7% |
| Molybdenum (Mo) | 0.4%-0.6% |
| Tungsten (W) | 9.3%-9.7% |
| Aluminum (Al) | 5.2%-5.7% |
| Tantalum (Ta) | 1.9%-2.1% |
| Boron (B) | 0.0025%-0.01% |
| Zirconium (Zr) | 0.0025%-0.01% |
| Hafnium (Hf) | 0.1%-0.3% |
| Nickel (Ni) | |
| optionally | |
| Yttrium (Y) | 0.005%-0.015% |

also optionally, in each case not more than:

| | |
|---|---|
| Silicon (Si) | 0.02% |
| Manganese (Mn) | 0.05% |
| Phosphorus (P) | 0.005% |
| Sulfur (S) | 0.001% |
| Titanium (Ti) | 0.01% |
| Iron (Fe) | 0.05% |
| Copper (Cu) | 0.01% |
| Vanadium (V) | 0.1% |
| Silver (Ag) | 0.0005% |
| Lead (Pb) | 0.0002% |
| Selenium (Se) | 0.0010% |
| Oxygen (O) | 0.0200% |
| Gallium (Ga) | 0.0030% |
| Bismuth (Bi) | 0.0010% |
| Nitrogen (N) | 0.0050% |
| Magnesium (Mg) | 0.0070%. |

The advantages according to the invention can be optimized further by a further suitable selection of process parameters for the additive manufacture, for example the scanning or irradiation rate, the laser power or the track-strip or “hatch” spacing.

The product comprising the alloy described is advantageously a component which is used in the hot gas path of a turbo machine, for example a gas turbine. In particular, the component can be a rotor blade or guide vane, a segment or ring segment, a burner part or a burner tip, a frame, a shield, a heat shield, a nozzle, seal, a filter, an opening or lance, a resonator, punch or a swirler or be a corresponding transition, insert or a corresponding retrofitted part.

1. A nickel-based superalloy at least comprising, (in percent by weight) elements:

| | |
|---|---|
| Carbon (C) | 0.04%-0.08% |
| Chromium (Cr) | 9.8%-10.2% |
| Cobalt (Co) | 10.3%-10.7% |
| Molybdenum (Mo) | 0.4%-0.6% |
| Tungsten (W) | 9.3%-9.7% |
| Aluminum (Al) | 5.2%-5.7% |
| Tantalum (Ta) | 1.9%-2.1% |
| Boron (B) | 0.0025%-0.01% |
| Zirconium (Zr) | 0.0025%-0.01% |
| Hafnium (Hf) | 0.1%-0.3% |
| Nickel (Ni) | |
| optionally | |
| Yttrium (Y) | 0.005%-0.015% |

also optionally, in each case not more than:

| | |
|---|---|
| Silicon (Si) | 0.02% |
| Manganese (Mn) | 0.05% |
| Phosphorus (P) | 0.005% |
| Sulfur (S) | 0.001% |
| Titanium (Ti) | 0.01% |
| Iron (Fe) | 0.05% |
| Copper (Cu) | 0.01% |
| Vanadium (V) | 0.1% |
| Silver (Ag) | 0.0005% |
| Lead (Pb) | 0.0002% |
| Selenium (Se) | 0.0010% |
| Oxygen (O) | 0.0200% |
| Gallium (Ga) | 0.0030% |
| Bismuth (Bi) | 0.0010% |
| Nitrogen (N) | 0.0050% |
| Magnesium (Mg) | 0.0070%. |

2. The alloy as claimed in claim 1, comprising:
yttrium (Y).

3. A process for producing a component, comprising:
using an alloy as claimed in claim 1 to produce the component.

4. The process as claimed in claim 3,
wherein a powder bed process or a buildup welding process is used.

5. The process as claimed in claim 3,
wherein a selective sintering process (SLS) or a selective melting process (SLM) is used.

6. The process as claimed in claim 3,
wherein a powder buildup welding process is used.

7. A product comprising:
an alloy as claimed in claim 1.

8. A nickel-based superalloy,
wherein the nickel-based superalloy consists of the elements of claim 1.

9. The process as claimed in claim 5,
wherein laser or electron radiation is used.

10. The process as claimed in claim 6,
wherein laser powder buildup welding process is used.

11. A product,
produced by the process of claim 3.
